(19) United States
(12) Patent Application Publication
(10) Pub. No.: US 2019/0238391 A1
(43) Pub. Date: Aug. 1, 2019

(54) ELECTRONIC DEVICE, SYSTEM, AND METHOD

(71) Applicant: DENSO TEN AMERICA Limited, Novi, MI (US)

(72) Inventors: Jun KAKENO, Waterford, MI (US); Masamitsu MIYAZAKI, Novi, MI (US)

(73) Assignee: DENSO TEN AMERICA Limited, Novi, MI (US)

(21) Appl. No.: 15/881,234

(22) Filed: Jan. 26, 2018

(51) Int. Cl. H04L 29/12; H04L 29/06; H04W 80/06

(52) U.S. Cl. CPC H04L 29/12207; H04W 80/06; H04L 29/06047; H04L 61/1535

(57) ABSTRACT

An electronic device comprises a communication device for communicating with an external server, local communication modules for communicating with another electronic device, and at least one controller. This at least one controller is configured to receive from the external server a universal unique ID (UUID) that is also sent by the server to the other electronic device; connect, by way of a first communication protocol of the local communication modules, with the other electronic device to which was sent the UUID; and while connected by the first communication protocol, connect to the other electronic device by way of a second communication protocol of the local communication modules.

### BACKGROUND

The present disclosure relates to apparatuses, systems, and methods for establishing communication between electronic devices.

Many electronic devices are capable of communicating with each other, and various communication protocols have been established to enable this communication. Bluetooth Classic, for example, is one such protocol intended for short-range, or local, communication between devices. It has seen widespread adoption particularly with portable electronics such as mobile phones. In Bluetooth Classic, data is divided into a plurality of packets, which is then transmitted over one of 79 designated Bluetooth frequency channels within the 2.4 GHz band.

Bluetooth Low Energy has more recently emerged as an alternative or companion to Bluetooth Classic. Bluetooth Low Energy employs a Universal Unique ID (“UUID”) as the key by which to connect devices. As long as both devices share this UUID, they may connect to each other. Compared to Bluetooth Classic, power consumption of Bluetooth Low Energy is significantly reduced, but so is the amount of data that is intended to be transmitted therethrough. Bluetooth Low Energy is therefore typically employed for applications that have no need to exchange a great deal of data but are required to operate on battery power for a significant amount of time at minimal cost.

### SUMMARY

But for electronic devices to communicate with each other, a connection process must first be performed. In the specific context of Bluetooth Classic, for example, part of this connection process is referred to as pairing. To begin pairing two Bluetooth devices, one device must first acknowledge the existence of the other, i.e., one device must be discoverable and the other device must scan and search for that discoverable device. This often requires a substantial amount of interaction on the part of the user of those devices. For example, the user must often physically set one of the Bluetooth-enabled devices so as to be discoverable and the other to be in discovery or scanning mode. This input can be performed manually and/or by voice, but either way it often requires the user to operate the two devices in sequence. Thereafter, the user may be required to identify the discoverable device from a list of discovered devices presented on the scanning device. The discovery process is then complete and the pairing process may begin.

As part of this pairing process, the two devices thereafter exchange a security key to encrypt their communications and make them secure. This exchange can be accomplished in multiple ways depending on, say, user preference or the display and input capabilities of the devices. It may be accomplished, for example, by a numerical comparison, in which the user is required to confirm that keys on both devices are the same. It may also be accomplished by way of a passcode entry, in which the user is required to enter a passcode on one of the two devices. Or the two devices may employ a Just Works method, typically reserved for devices without user input capabilities, in which no key or passcode need be exchanged by the user.

So as can be seen, current connection processes of electronic devices require a substantial amount of user intervention. Not only is the user often required to physically input information, but this user may be required to make certain decisions at specific stages of the connection process to ensure that it is performed successfully. This can be problematic because a successful connection between devices thus depends on the level of the user's understanding of and familiarity with the technology. And even if the devices themselves provide text or voice prompts in the attempt to guide the user through the process, misinterpretation or non-observance of that guidance by the user can lead to failure of the devices to connect to each other. There is thus a need to automate this connection process to reduce or eliminate user intervention and thereby potentially reduce failed connection attempts and user frustration.

There may thus be provided, according to one or more aspects of the present disclosure, an electronic device that comprises a communication device for communicating with an external server; local communication modules for communicating with another electronic device; and at least one controller. The at least one controller may be specifically configured to receive from the external server a universal unique ID (UUID) that is also sent by the server to the other electronic device; connect, by way of a first communication protocol of the local communication modules, with the other electronic device to which was sent the UUID; and while connected by the first communication protocol, connect to the other electronic device by way of a second communication protocol of the local communication modules.

Other aspects of the present disclosure may include a system comprising a first electronic device and a second electronic device. The first electronic device may in turn comprise a communication device for communicating with an external server; local communication modules; and at least one controller specifically configured to: send to the server an identifier; receive from the server, in response to the identifier, a universal unique ID (UUID); and announce the UUID by way of a first communication protocol of the local communication modules. The second electronic device may comprise a communication device for communicating with the external server; local communication modules; and at least one controller specifically configured to: transmit to the server a request for the UUID, the request including the identifier that is shared by the first electronic device; receive from the server, in response to the request, the UUID that is also sent by the server to the first electronic device; search for devices having the UUID by way of the first communication protocol; and determine if the UUID of the first electronic device matches the UUID of the second electronic device. The controllers of the first and second electronic devices may be further configured to connect the first and second electronic devices by way of the first communication protocol if the UUID of the first electronic device is determined to match that of the second electronic device. The at least one controller of the first electronic device may be yet further configured to send data to the second electronic device by way of the first communication protocol. And in response to receiving the data from the first electronic device by way of the first communication protocol, the at least one controller of the second electronic device may be further configured to make the second electronic device detectable by way of a second communication protocol of the local communication modules.

And yet other aspects of the present disclosure comprise a method of connecting electronic devices, the method comprising: receiving, by a first of the electronic devices and in response to the first electronic device sending an identifier to an external server, a universal unique ID (UUID) from the server; receiving, by a second of the electronic devices and in response to the second electronic device sending a request transmitting the identifier to the server, the UUID from the server; announcing, by the first electronic device, the UUID over a first communication protocol; determining, by the second electronic device, if the UUID of the first electronic device matches the UUID of the second electronic device; connecting the first and second electronic devices by way of the first communication protocol if the UUID of the first electronic device is determined to match that of the second electronic device; sending data from the first electronic device to the second electronic device by way of the first communication protocol; and in response to receiving the data from the first electronic device by way of the first communication protocol, making the second electronic device detectable by way of a second communication protocol.

These and other non-limiting aspects of the present disclosure will be described with reference to the following detailed embodiments and accompanying drawings.

### BRIEF DESCRIPTION OF THE DRAWINGS

FIG. 1 shows a system according to one or more aspects of the present disclosure.

FIG. 2 shows a configuration of one electronic device according to one or more aspects of the present disclosure.

FIG. 3 shows a configuration of another electronic device according to one or more aspects of the present disclosure.

FIG. 4 shows a configuration of a server according to one or more aspects of the present disclosure;

FIG. 5 shows a flowchart outlining an exemplary process performed by the electronic device of FIG. 2.

FIG. 6 shows a flowchart outlining an exemplary process performed by the electronic device of FIG. 3.

FIG. 7 shows a flowchart outlining an exemplary process performed by the server of FIG. 4.

FIG. 8 shows a flowchart outlining an exemplary connection process between the devices of FIGS. 2 and 3 that may follow the processes of FIGS. 5-7.

### DETAILED DESCRIPTION OF EMBODIMENTS

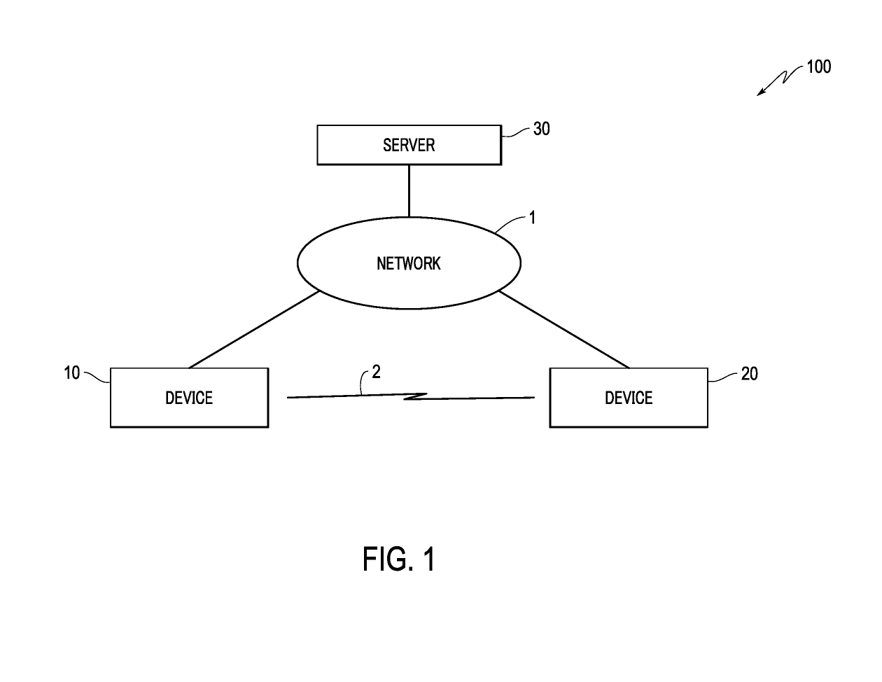

FIG. 1 shows a configuration of an exemplary system according to one or more aspects of the present disclosure. This system may include a first electronic device 10, a second electronic device 20, and a server 30 connectable to each other by way of a network 1. This network 1 may be formed, for example, by way of radio frequency (“RF”) communication of the devices 10 and 20 and the server 30. RF communication here may refer to the wireless electromagnetic signal carrier of data, in which the radio spectrum of frequencies is delegated into different bands used for different purposes. In this case, the devices 10, 20, and server 30 may communicate over the same frequency bands as those typically employed by mobile telephones. The network 1 may also be a wide area network such as the Internet through which the devices 10, 20, and server 30 communicate. It may also be any other communication medium sufficient to allow communication between the devices 10, 20 and server 30 over distance. And as explained in greater detail below, the devices 10 and 20 may also communicate with each other by way of local communication 2.

The device 10 may be, for example, a mobile telephone, smartphone, or other portable electronic device able to be carried by a user. And the device 20 may be a radio or other infotainment system installed or installable in a vehicle such as an automobile. However, the specific constitution of the devices 10, 20 is not limited. They may be, for example, any electronic device or machinery with wireless communication capability.

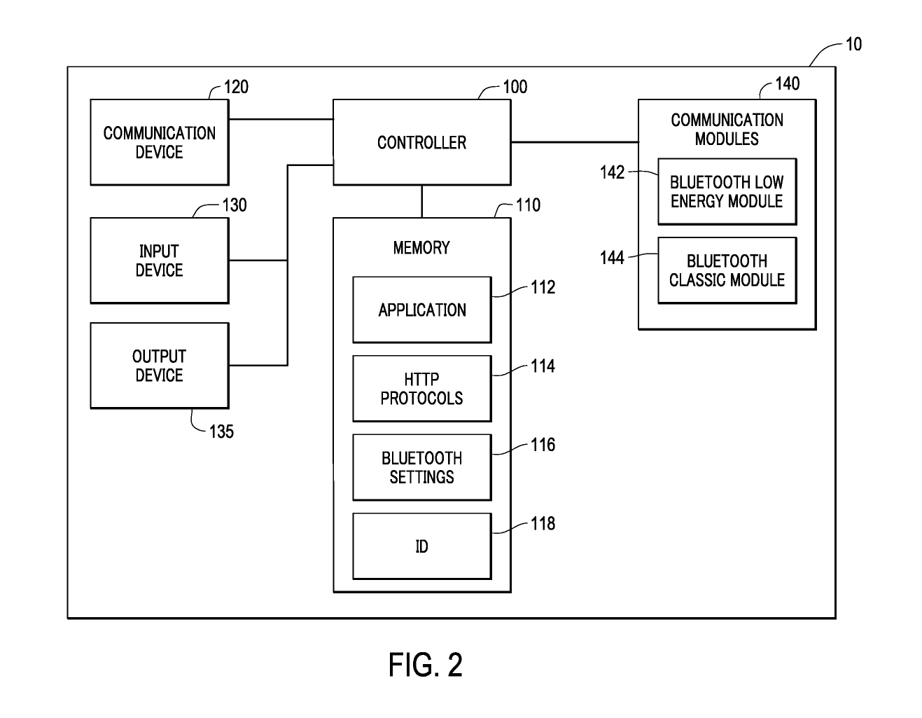

FIG. 2 shows an exemplary arrangement of the first electronic device 10. This device may include a controller 100, a memory 110, a communication device 120, input device 130, output device 135, and local communication modules 140. The controller 100 may be a CPU, an MPU (optionally including a RAM and/or ROM), or any known or later-developed processor, circuit, or device for executing programs and instructions so as to operate the device 10. The memory 110 may in turn be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory, or the like. Similarly, the non-alterable or fixed memory can be implemented using any one or more of ROM, PROM, EPROM, EEPROM, an optical ROM disk, such as CD-ROM or DVD-ROM disk and disk drive, or the like. The memory 110 may store various computer programs or instructions to be executed by, e.g., the controller 100. It may store, for example, an application 112 and HTTP protocols 114 to enable communication with other devices. The communication device 120 may comprise the necessary wired or wireless hardware and/or software to enable communication by way of the network 1. It may be, for example, an RF transceiver through which electromagnetic signals are carried from one device to another. This communication device 120 may facilitate communication over the same bands as, e.g., mobile phones, or it may facilitate Wi-Fi communication to a local router, through which communication is made to the network 1. The input device 130 may be one or more of a keyboard, a mouse, a trackball, a touch screen, a virtual reality glove, or any known or later-developed device for inputting data and/or control signals to the first electronic device 10. And the output device 135 may be one or more of a display screen, speaker, or any known or later-developed device for outputting data from the device 10.

The local communication modules 140 may include individual modules capable of establishing the local communication 2 with the electronic device 20 in the vicinity of the first electronic device 10. For example, these local communication modules may include as a first local communication module a Bluetooth Low Energy Module 142 and a Bluetooth Classic Module 144 as a second local communication module. Each of these modules may include the necessary hardware, e.g., processor, memory, and associated circuitry, and software necessary to perform communication by way of Bluetooth Low Energy and Bluetooth Classic, respectively. Settings for these modules 142 and 144, e.g., whether ON or OFF, may be controlled by way of Bluetooth setting instructions 116 stored in the memory 110. Bluetooth Low Energy and Bluetooth Classic may respectively serve as non-limiting examples of a first communication protocol and a second communication protocol.

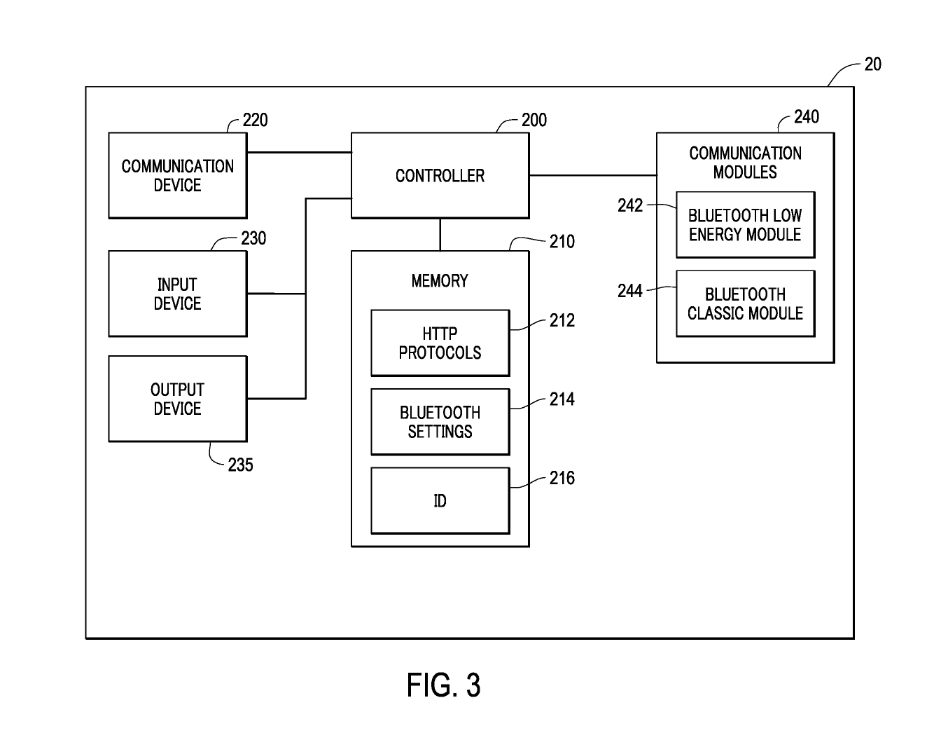

FIG. 3 shows an exemplary arrangement of the second electronic device 20. Similar to the first electronic device 10, the device 20 may include a controller 200, a memory 210, a communication device 220, input device 230, output device 235, and local communication modules 240. The controller 200 may be a CPU, an MPU (optionally including a RAM and/or ROM), or any known or later-developed processor, circuit, or device for executing programs and instructions so as to operate the device 20. The memory 210 may in turn be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory, or the like. Similarly, the non-alterable or fixed memory can be implemented using any one or more of ROM, PROM, EPROM, EEPROM, an optical ROM disk, such as CD-ROM or DVD-ROM disk and disk drive, or the like. The memory 210 may store various computer programs or instructions to be executed by, e.g., the controller 200. It may store, for example, HTTP protocols 212 to enable communication with other devices. The communication device 220 may comprise the necessary wired or wireless hardware and/or software to enable communication by way of the network 1. It may be, for example, an RF transceiver through which electromagnetic signals are carried from one device to another. This communication device 220 may facilitate communication over the same bands as, e.g., mobile phones, or it may facilitate Wi-Fi communication to a local router, through which communication is made to the network 1. The input device 230 may be one or more of a keyboard, a mouse, a trackball, a touch screen, a virtual reality glove, or any known or later-developed device for inputting data and/or control signals to the second electronic device 20. And the output device 235 may be one or more of a display screen, speaker, or any known or later-developed device for outputting data from the device 20.

The local communication modules 240 may include individual modules capable of establishing the local communication 2 with the electronic device 10 when located in the vicinity of the first electronic device 10. For example, the local communication modules may include as a first local communication module a Bluetooth Low Energy Module 242 and a Bluetooth Classic Module 244 as a second local communication module. Each of these modules may include the necessary hardware, e.g., processor, memory and associated circuitry, and software necessary to perform communication by way of Bluetooth Low Energy and Bluetooth Classic, respectively. Settings for these modules 242 and 244 may be controlled by way of Bluetooth setting instructions 214 stored in the memory 210.

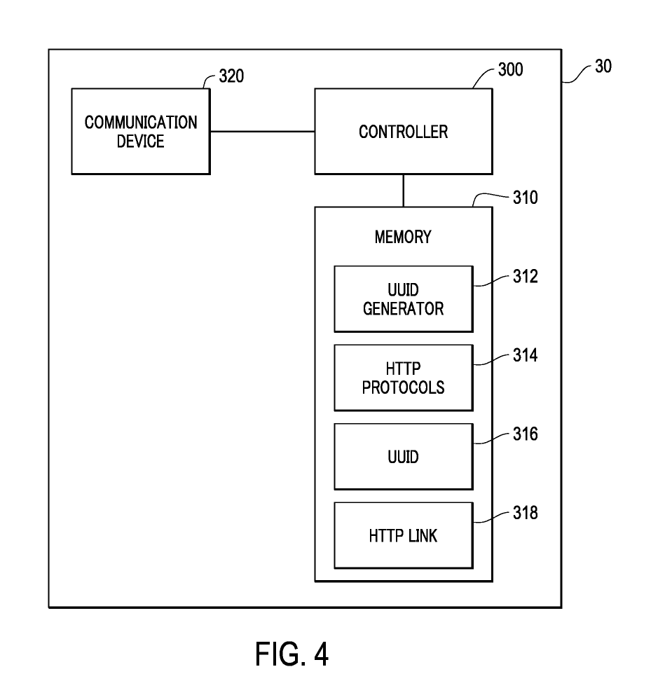

FIG. 4 then shows an exemplary arrangement of the server 30. Like the first and second electronic devices 10, 20, the server 30 may include a controller 300, memory 310, and communication device 320. The controller 300 may be a CPU, an MPU (optionally including a RAM and/or ROM), or any known or later-developed processor, circuit, or device for executing programs and instructions so as to operate the server 30. The memory 310 may in turn be implemented using any appropriate combination of alterable, volatile or non-volatile memory or non-alterable, or fixed, memory. The alterable memory, whether volatile or non-volatile, can be implemented using any one or more of static or dynamic RAM, a floppy disk and disk drive, a writeable or rewriteable optical disk and disk drive, a hard drive, flash memory, or the like. Similarly, the non-alterable or fixed memory can be implemented using any one or more of ROM, PROM, EPROM, EEPROM, an optical ROM disk, such as CD-ROM or DVD-ROM disk and disk drive, or the like. The memory may store various computer programs or instructions to be executed by, e.g., the controller 300. It may store, for example, instructions 312 for generating UUIDs (described below) and HTTP protocols 314 to enable communication with other devices. The communication device 320 may comprise the necessary hardware and/or software to enable communication by way of the network 1 such as is well-known to those skilled in the art.

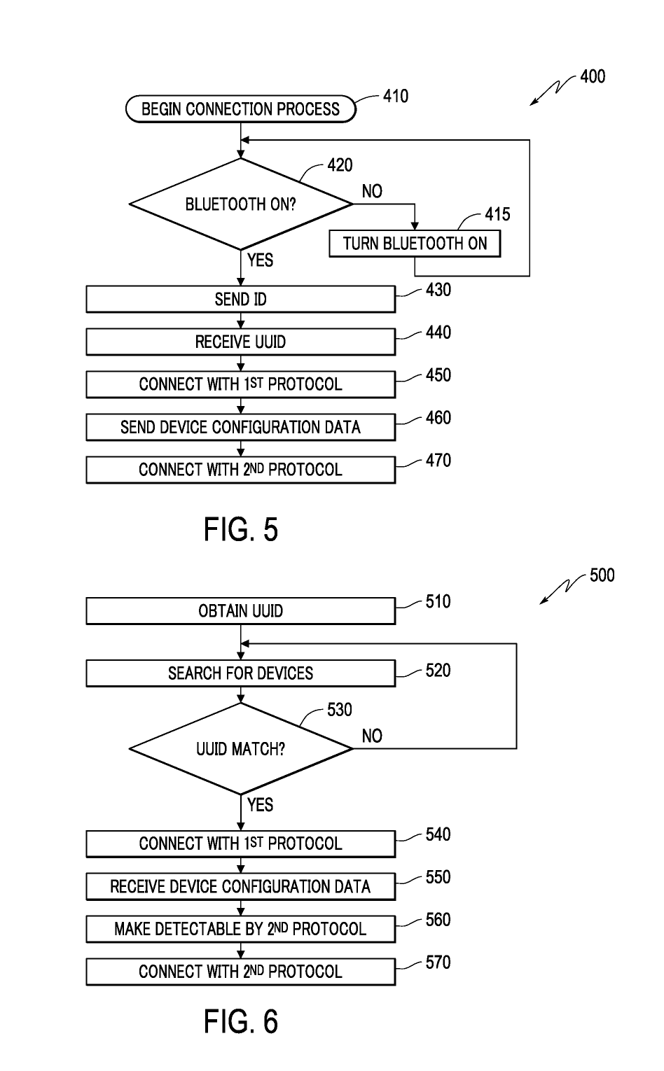

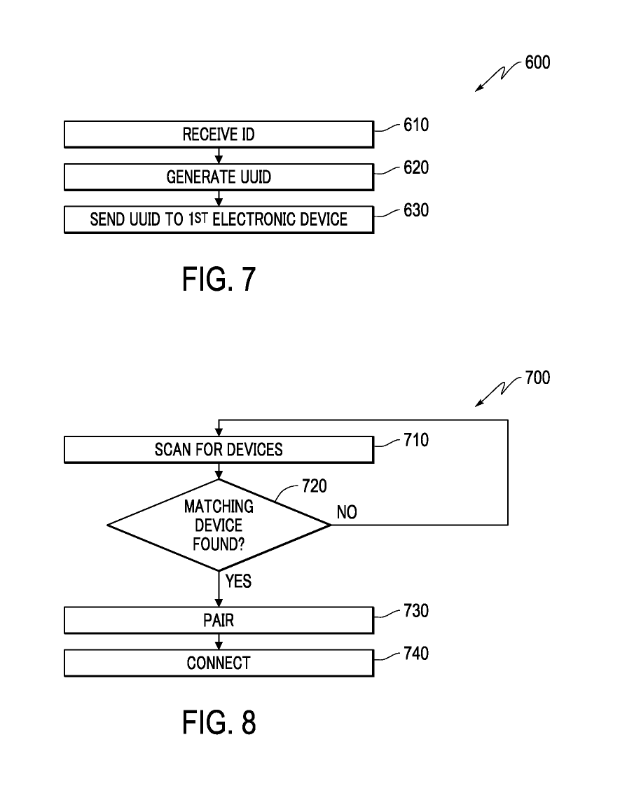

FIG. 5 shows a flowchart outlining steps 400 executed by the first electronic device 10 during a process of connecting to the second electronic device 20. FIG. 6 shows a flowchart outlining steps 500 executed by the second connection device 20 during that process. And FIG. 7 shows steps 600 executed by the server 30. For the purposes of this non-limiting example, local communication 2 is to be established between the electronic devices 10 and 20 by way of Bluetooth Low Energy and Bluetooth Classic.

In a first step 410 shown in FIG. 5, the connection process begins. This process may begin by way of the user operating the input device 130 to open the application 112 stored on the memory 110. This application may require connection to the electronic device 20 by way of Bluetooth Classic, so under its instructions, the controller 100 inquires using the Bluetooth setting instructions 116 at step 420 whether one or both of the Bluetooth Low Energy and Bluetooth Classic modules 142 and 144 are currently enabled or ON. If these modules are so enabled, the process proceeds to step 430. But if these modules are not enabled or OFF, the process proceeds to step 415 at which one or both of the modules 142 and 144 are turned ON. Once having turned these modules ON at step 415, the process may then return to step 420 to again confirm that those modules are ON.

At step 430, the first electronic device 10 may transmit, by way of the communication device 120 and the network 1, an identifier or ID 118 stored in the memory 110 to the server 30. This identifier 118 may be shared by the second electronic device 20, and it may be associated with the vehicle within which the electronic device 20 may be provided. For example, the identifier 118 may be the Vehicle Identification Number (“VIN”) of that vehicle or automobile. The identifier 118 may be entered into the first electronic device 10 by way of the input device 130. It can be entered, say, by user input on a keyboard or touchscreen or through image recognition by which a camera of the first electronic device 10 takes an image of, e.g., a barcode or other object, to obtain the identifier 118. To transmit the identifier 118, the device 10 may place an HTTP call using the HTTP protocols 114 to POST the identifier to the server 30.

At step 610 shown in FIG. 7, the server 30 may receive the identifier 118 by way of the communication device 320 and the HTTP protocols 314. And under the control of the UUID generator 312, which may be software or other instructions stored on the memory 310 to be executed by the controller 300, the server 30 may generate at step 620 a UUID 316 based on receipt of the identifier 118. The UUID 316 may be random. In the case of Bluetooth Low Energy, the UUID 316 may be a 128 bit number, and it may be version 4 UUID, described by RFC 4122. Then at step 630, the server 30 may store the generated UUID 316 in a link 318 and send as a response body of the POST call that UUID 316 back to the electronic device 10 to be stored in the memory 110 at step 440. Along with the UUID 316, the server 30 may send a user profile, which stores user preferences for, e.g., operating the electronic device 20 or the automobile within which it may be provided.

At step 510 shown in FIG. 6, the second electronic device 20 may transmit, by way of the communication device 220 and the network 1, an identifier or ID 216 stored in the memory 210 to the server 30. To transmit this identifier 216, the device 20 may place a GET HTTP call to the server 30 using the HTTP protocols 212. This call may be placed to the server 30 periodically, say every 30 seconds or minute. Alternatively, the GET call may be placed based on the proximity of the first electronic device 10 to the second electronic device 20. Or the server 30 may send the UUID 316 to the second electronic device 20 automatically when the UUID changes, thereby avoiding the necessity of device 20 making periodic GET calls to the server 30. As the identifier 216 is shared by the electronic device 10 and is thus the same as the identifier 118, the second electronic device 20 may obtain as part of step 510 the stored UUID 316 from the link 318 and store it in the memory 210. If no UUID 316 is currently stored at the link 318, the server 30 may return an error, e.g., an error 404, back to the device 20. At this point, the electronic devices 10 and 20 should both have the same UUID.

The electronic device 10, in step 440, may then announce the acquired UUID 316 by using the local communication modules 140. In the context of this specific non-limiting example, the controller 100 may cause the Bluetooth Low Energy module 142 to advertise the UUID 316 by way of Bluetooth Low Energy. At step 520, the electronic device 20 may simultaneously search using its local communication modules 240 for other devices broadcasting the UUID 316. In the context of this specific non-limiting example, the controller 200 may cause the Bluetooth Low Energy module 242 to scan for the UUID 316 by way of Bluetooth Low Energy. And at step 530, the controller 200 may determine whether the UUIDs respectively stored in the memories 110 and 210 of the devices 10, 20 are matched. If they are not matched, scanning for the UUID 316 may continue by the second electronic device 20. But if the UUIDs are determined to match, connection between the devices 10 and 20 may be established at steps 450 and 540 by way of Bluetooth Low Energy.

The controller 100, based on instructions from the application 112, may then create a service using the UUID 316 as the key to communicate with the device 20 over Bluetooth Low Energy. At step 460, this service may be used as a conduit to transfer data from the electronic device 10 to the electronic device 20 and for the device 20 to alert the device 10 of that data's receipt. For example, this data may be the user profile data sent by the server 30 or it may be other device configuration data that contains user preferences for operating the electronic device 20. It could be, say, user-preferred channel presets, preferred seat positioning, mirror positioning and climate control settings, and/or paid service subscription information. Under the control of the application 112, the controller 100 may segment this transferred data into a plurality of parts of, say, a few KBs each, and transmit these parts in sequence to the device 20. For each data part received, the device 20 may return to the device 10 a response notification, upon receipt of which the controller 100 may send the next available data part until all parts of the data are sent. Bluetooth Low Energy thus provides an initial opportunity to transmit relatively large amounts of data between the devices 10 and 20. In the context of this specific non-limiting example, in which data may be transmitted to and stored in the memory 210, the electronic device 20 can thus be easily and effortlessly configured to a user's liking with only minimal, if any, intervention by that user.

The electronic device 20 may receive the data transmitted from the device 10 over Bluetooth Low Energy at step 550. And because of that receipt, the controller 200 may access at step 560 the Bluetooth setting instructions 214 to turn on the second communication module to make the electronic device 20 detectable by way of the second communication protocol. In the context of this specific non-limiting example, the processor 200 accesses the Bluetooth Classic Module 244 to make the device 20 discoverable by way of Bluetooth Classic. Receipt of the data transmitted from the electronic device 10 over Bluetooth Low Energy may thus cause the device 20 to make itself discoverable. And at steps 470 and 570, the electronic devices 10 and 20 connect to each other by way of the second communication protocol.

FIG. 8 shows one exemplary process 700 by which the devices 10 and 20 may be connected over Bluetooth Classic. At first step 710, instructions from the application 112 may cause the controller 100 to scan by way of the Bluetooth Classic Module 244 for other devices discoverable over Bluetooth Classic. If at step 720 the controller 100 determines that a device name matching that of the device 20 has been found, it may begin the pairing process at step 730. The device name may be hard-coded into the application 112 stored in the memory 110 of the first electronic device 10, for example. Hard-coding would be specifically advantageous if the application 112 is customer-specific, e.g., limited to one particular brand of vehicle into which the device 20 may be installed. The device name may alternatively be entered by the user, especially if the application 112 is a universal application.

As another non-limiting possibility, the device name may be included in the user profile data sent from the server 30 to the device 10 along with the UUID 316. If no such device is found, the scanning process may continue. Also prior to the pairing step 730, and under the control of the application 112, the Bluetooth setting instructions 214 may be set so that the device type of the electronic device 20 is NO INPUT/NO OUTPUT. This may occur even if the electronic device 20 has input/output capabilities such as, e.g., a touchscreen or keyboard. As previously mentioned, the process of pairing Bluetooth Classic devices may differ depending on the capabilities of the devices to be connected. Because the type of the electronic device 20 is set to NO INPUT/NO OUTPUT, the Just Works pairing method may be employed and a confirmation screen may not be displayed on the output device 235 during the pairing process. This may further limit required user interaction and thus avoid additional user confusion and frustration. Then at step 740, the paired devices 10 and 20 connect to each other by way of Bluetooth Classic.

According to the above description, devices, a system, and associated method are provided by which two electronic devices may be connected to each other to communicate. As discussed previously, by using a first communication protocol such as Bluetooth Low Energy, connection using a second protocol such as Bluetooth Classic may be achieved. Bluetooth Low Energy is particularly advantageous because it does not require prior pairing to exchange information between the devices. Further, using a low-energy-consuming protocol such as Bluetooth Low Energy may be used to help establish communication with one that uses more energy, thus potentially improving battery life of the device. Further, the connection can be accomplished with minimal or no user intervention. This has the potential to reduce failures of the connection process as well as user frustration.

While the disclosure has been presented in conjunction with exemplary embodiments, these embodiments should be viewed as illustrative, not limiting of the present invention. Indeed, various modifications, substitutions, or the like are possible within the spirit and scope of the invention. For example, although Bluetooth Low Energy and Bluetooth Classic have been provided as specific examples of the first and second communication protocols, others may be employed. Indeed, the second communication protocol may be any wireless communication protocol that requires pre-configuration in order to connect electronic devices. It may be, for example, Wi-Fi, in which context the communication devices 10 and 20 may be any Wi-Fi-capable device. Because Wi-Fi requires searching, discovery, and password confirmation to exchange information between the two devices to be connected, the above process may be advantageous. The first communication protocol may alternatively be near-field communication (“NFC”). Further, although HTTP has been provided as an exemplary mechanism through which the devices 10, 20 communicate with the server 30, the present invention is not so limited. Other mechanisms include FTP, HTTPS, SFTP, and WS. And although the various steps of the processes 400, 500, 600, and 700 are described as being performed by a controller, each of these steps may be performed by its own functional unit implemented by, e.g., a dedicated system such as an Application Specific Integrated Circuit (“ASIC”).

What is claimed is:

1. An electronic device, comprising:
a communication device for communicating with an external server;
local communication modules for communicating with another electronic device; and
at least one controller specifically configured to:
receive from the external server a universal unique ID (UUID) that is also sent by the server to the other electronic device;
connect, by way of a first communication protocol of the local communication modules, with the other electronic device to which was sent the UUID; and
while connected by the first communication protocol, connect to the other electronic device by way of a second communication protocol of the local communication modules.

2. The electronic device of claim 1, wherein the at least one controller is further configured to:
prior to receiving the UUID from the external server, send to the server an identifier that is shared by the other electronic device;
prior to connecting to the other electronic device with the first communication protocol, announce the UUID by way of the first communication protocol; and
prior to connecting to the other electronic device with the second communication protocol, search for devices connectable by way of the second communication protocol.

3. The electronic device of claim 2, wherein the at least one controller is further configured to send data to the other electronic device by way of the first communication protocol.

4. The electronic device of claim 3, wherein the first communication protocol is Bluetooth Low Energy.

5. The electronic device of claim 4, wherein the second communication protocol is Bluetooth Classic.

6. The electronic device of claim 4, wherein the data sent to the other electronic device by way of Bluetooth Low Energy is device configuration information.

7. The electronic device of claim 5, further comprising:
a display; and
an input device by which a user inputs data into the electronic device, wherein:
the at least one controller connects to the other electronic device using Bluetooth Classic by way of a pairing process; and
during the pairing process, display and input capability configuration of the electronic device is set to disabled.

8. The electronic device of claim 1, wherein the at least one controller is further configured, in response to receiving data from the other electronic device by way of the first communication protocol, to make the electronic device detectable by way of the second communication protocol.

9. The electronic device of claim 8, wherein the at least one controller is further configured to:
prior to receiving the UUID from the external server, transmit to the server a request for the UUID, the request including an identifier that is shared by the other electronic device; and
prior to connecting to the other electronic device with the first communication protocol, search for devices having the UUID by way of the first communication protocol and determine that the UUID of the other electronic device matches that of the electronic device.

10. The electronic device of claim 9, wherein the first communication protocol is Bluetooth Low Energy.

11. The electronic device of claim 10, wherein the second communication protocol is Bluetooth Classic.

12. The electronic device of claim 10, wherein the data received from the other electronic device by way of Bluetooth Low Energy is device configuration information.

13. The electronic device of claim 11, further comprising:
a display; and
an input device by which a user inputs data into the electronic device, wherein:
the at least one controller connects to the other electronic device using Bluetooth Classic by way of a pairing process; and
during the pairing process, display and input capability configuration of the electronic device is set to disabled.

14. The electronic device of claim 9, wherein the at least one controller transmits the request to the external server at predetermined intervals.

15. A system, comprising:
a first electronic device comprising:
a communication device for communicating with an external server;
local communication modules; and
at least one controller specifically configured to:
send to the server an identifier;
receive from the server, in response to the identifier, a universal unique ID (UUID); and
announce the UUID by way of a first communication protocol of the local communication modules; and
a second electronic device comprising:
a communication device for communicating with the external server;
local communication modules; and
at least one controller specifically configured to:
transmit to the server a request for the UUID, the request including the identifier that is shared by the first electronic device;
receive from the server, in response to the request, the UUID that is also sent by the server to the first electronic device;
search for devices having the UUID by way of the first communication protocol; and
determine if the UUID of the first electronic device matches the UUID of the second electronic device, wherein:
the controllers of the first and second electronic devices are further configured to connect the first and second electronic devices by way of the first communication protocol if the UUID of the first electronic device is determined to match that of the second electronic device;
the at least one controller of the first electronic device is further configured to send data to the second electronic device by way of the first communication protocol; and
in response to receiving the data from the first electronic device by way of the first communication protocol, the at least one controller of the second electronic device is further configured to make the second electronic device detectable by way of a second communication protocol of the local communication modules.

16. The system of claim 15, wherein the at least one controller of the second electronic device transmits the request to the external server at predetermined intervals.

17. The system of claim 16, wherein the first communication protocol is Bluetooth Low Energy.

18. The system of claim 17, wherein the second communication protocol is Bluetooth Classic.

19. A method of connecting electronic devices, the method comprising:
receiving, by a first of the electronic devices and in response to the first electronic device sending an identifier to an external server, a universal unique ID (UUID) from the server;
receiving, by a second of the electronic devices and in response to the second electronic device sending a request transmitting the identifier to the server, the UUID from the server;
announcing, by the first electronic device, the UUID over a first communication protocol;
determining, by the second electronic device, if the UUID of the first electronic device matches the UUID of the second electronic device;
connecting the first and second electronic devices by way of the first communication protocol if the UUID of the first electronic device is determined to match that of the second electronic device;
sending data from the first electronic device to the second electronic device by way of the first communication protocol; and
in response to receiving the data from the first electronic device by way of the first communication protocol, making the second electronic device detectable by way of a second communication protocol.

20. The method of claim 19, wherein the second electronic device transmits the request to the server at predetermined intervals.

21. The method of claim 20, wherein the first communication protocol is Bluetooth Low Energy.

22. The electronic device of claim 21, wherein the second communication protocol is Bluetooth Classic.
